(19) United States
(12) Patent Application Publication
(10) Pub. No.: US 2011/0250929 A1
(43) Pub. Date: Oct. 13, 2011

(54) CURSOR CONTROL DEVICE AND APPARATUS HAVING SAME

(75) Inventor: TSUNG-YU LIN, Tu-Cheng (TW)

(73) Assignee: HON HAI PRECISION INDUSTRY CO., LTD., Tu-Cheng (TW)

(21) Appl. No.: 12/857,575

(22) Filed: Aug. 17, 2010

(30) Foreign Application Priority Data
Apr. 13, 2010 (TW) 99111385

(51) Int. Cl. H04M 1/00; G09G 5/08

(52) U.S. Cl. 455/556.1; 345/157

(57) ABSTRACT

A cursor control device includes a detection module having an image capturing unit defining a detectable region, an information identifying module including an information storage unit and an information comparing unit, and a signal processing unit. The information comparing unit is configured for identifying the object by comparing a captured image of the object with the predetermined images stored in the information storage. The detection module is configured for analyzing the captured successive images to determine the movement track of the identified object. The signal processing unit is configured for generating a cursor control signal based on the movement track signals. An apparatus, such as a mobile phone using the cursor control device is also provided.

### BACKGROUND

1. Technical Field

The present disclosure relates to a cursor control device and an apparatus having such cursor control device.

2. Description of Related Art

Currently, besides touch control, a mouse is usually used for controlling a cursor on a device. However, the mouse is not easy to carry with ease, and when in use, the mouse has to be moved on a pad or a flat desk surface. The touch control needs the finger moves to different positions of a touch panel. With the ongoing development of large display, touch control becomes harder and harder.

What is needed, therefore, is a cursor control device and an apparatus having same, which can overcome the above shortcomings.

### BRIEF DESCRIPTION OF THE DRAWINGS

Many aspects of the present cursor control device and apparatus can be better understood with reference to the following drawings. The components in the drawings are not necessarily drawn to scale, the emphasis instead being placed upon clearly illustrating the principles of the present cursor control device and apparatus. Moreover, in the drawings, like reference numerals designate corresponding parts throughout the several views.

FIG. 1 is a schematic view of a cursor control device in accordance with an embodiment.

FIG. 2 is a schematic view showing systems in the cursor control device of FIG. 1.

FIG. 3 is a schematic view showing an apparatus including a cursor control device, a host and a display.

### DETAILED DESCRIPTION

Embodiments of the present cursor control device and apparatus will now be described in detail below and with reference to the drawings.

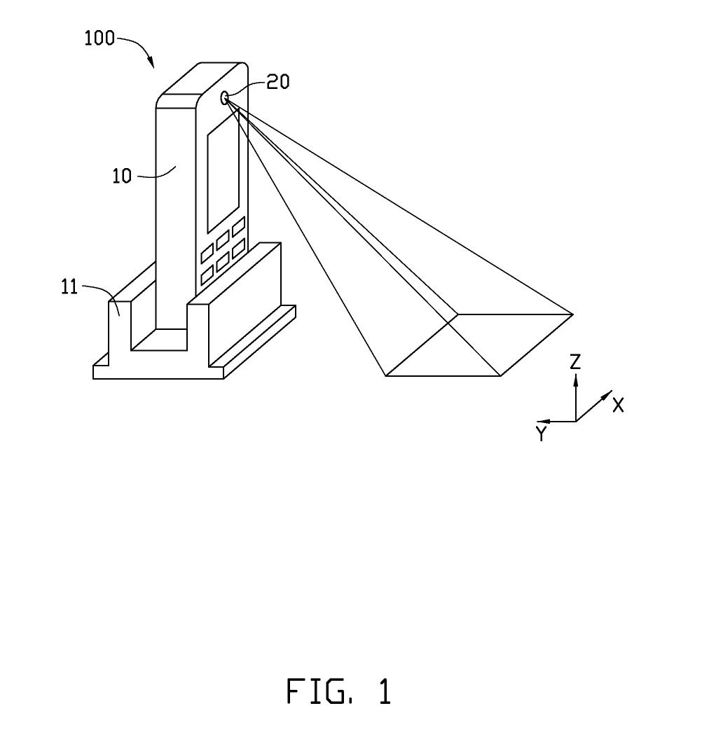

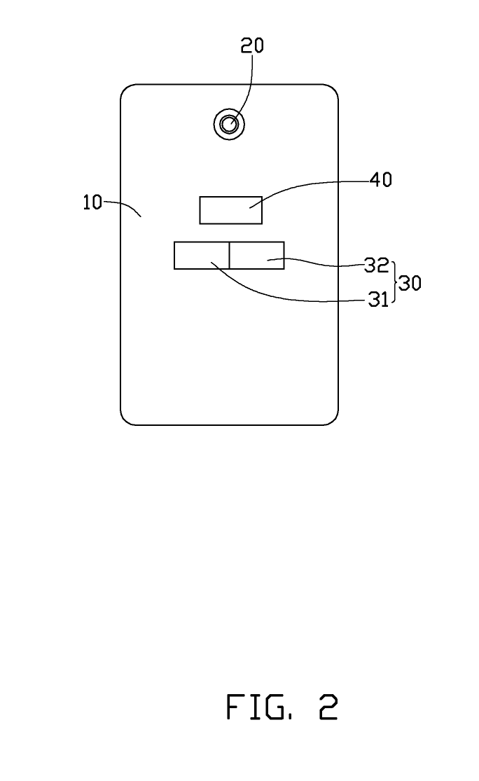

Referring to FIGS. 1 and 2, an exemplary cursor control device 100, includes a main body 10, a detection module 20, an information identifying module 30 and a signal processing unit 40. The detection module 20, the information identifying module 30 and the signal processing unit 40 are mounted in the main body 10.

The main body 10 can be located on a bracket 11 which can be located on a desk or on other objects. The detection module 20 is located in a top end of the main body 10. The detection module 20 has an image capturing unit (camera module) defining a detectable region on the desk. If user's fingers or other objects move in the detectable region, the detection module 20 is capable of capturing successive images of the fingers or other objects, then converting the successive images into movement track signals of the fingers and other objects in the detectable region.

The information identifying module 30 is electrically connected to the detection module 20 to receive signals from the detection module 20 and feedback thereto. The information identifying module 30 includes an information storage unit 31 and an information comparing unit 32. The information storage unit 31 stores predetermined images of fingers and other predetermined objects. The comparing element 32 is used to compare in-time captured images from the detection module 20 with the predetermined images stored in the information storage unit 31. If a compared result shows an in-time captured image is inconsistent with one of the predetermined images, the information identifying module 30 feedbacks nothing to the detection module 20.

If a compared result shows an in-time captured image is consistent with one of the predetermined images, the information identifying module 30 feedbacks a tracking order to the detection module 20, then the detection module 20 captures successive images of the identified object, and converts the successive images into movement track signals.

In application, the information storage unit 31 can store images of finger ends of one or more predetermined users, such as figure images of the finger ends. When one of such fingers appears on the detectable region, the detection module 20 can capture an image of the finger and the information comparing unit 32 can receive an image signal from the detection module 20 and compare the image signal with the predetermined images stored in the information storage unit 31. After receiving a tracking order from the information identifying module 30, the detection module 20 begins to capture successive images of the finger according to movements of the finger, and convert the successive images into movement track signals of the finger. The movements of the finger include movements in a three-dimensional space within the detectable region, that is, the detection module 20 is configured for determining the three-dimensional movement track of the object in the detectable region.

The signal processing unit 40 is electrically connected to the detection module 20 and configured to covert the movement track signals into cursor control signals. The signal processing unit 40 can also read a user's click and double-click in the detectable region to be those similar to the user's click and double-click on the left mouse button and right mouse right button based on movements of the user's fingers along a Z-axis.

The cursor control device 100 can be disposed in front of users, and a host which to be controlled can be located in front of the cursor control device 100, not necessarily facing thereto as long as the users can read display of the host. The cursor control device 100 has a wire transmission system and a wireless transmission system mounted therein, such that the signal processing unit 40 can be connected to the host via wires, wireless Bluetooth or wireless infrared transmission system.

The information identifying module 30 further includes a user's ID and password identifying unit. The main body 10 includes a keyboard, a display screen mounted thereon to support the user's ID and password identifying unit. If an input ID or password is correct, the information identifying module 30 can also give the tracking order to the detection module 20. In particular, each ID corresponds to a cursor defined in the cursor control device 100, and the cursors in the cursor control device 100 can have different designs which then shown on a display.

It is understood that the main body 10 can be a mobile phone. The information identifying module 30 can be called an object segmentation module. The wire transmission system and wireless transmission system are configured to be a signal sending module.

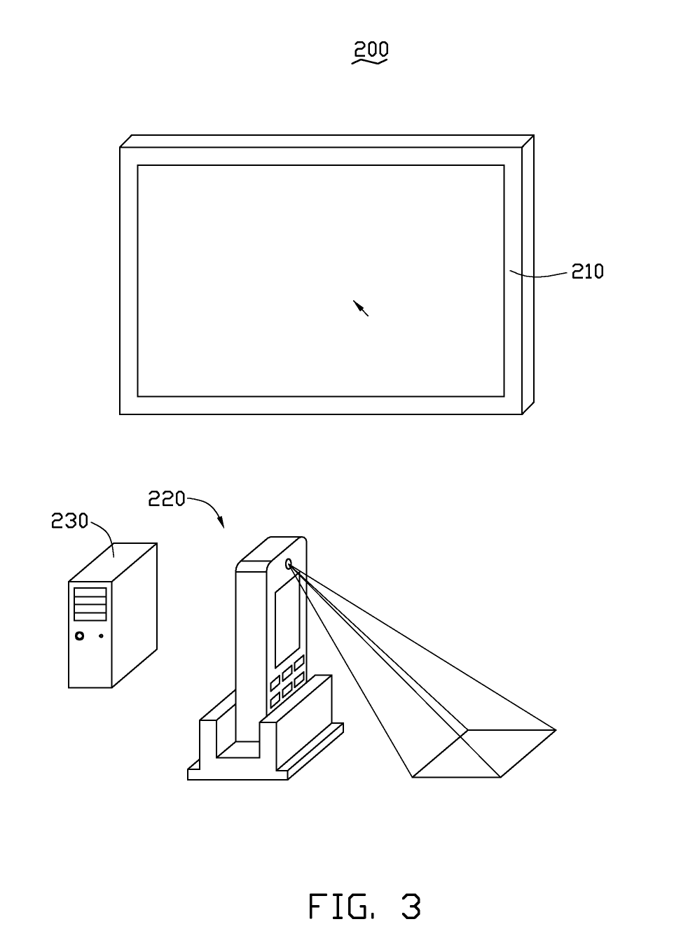

Referring to FIG. 3, an apparatus 200 includes a host 230, a display 210 and at least one cursor control device 220. The host 230 is compatible with one and more cursor control devices 220 at both a same time and a different time, with each cursor control device 220 operated by a person. The cursor control device 220 is the same as the cursor control device 100 illustrated above. Each cursor control device 220 corresponds to one or more cursor shown on the display 210.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A cursor control device comprising:
a detection module having an image capturing unit defining a detectable region, the detection module being capable of capturing successive images of the detectable region and analyzing the successive images to generate a movement track signal representative of a movement track of a moving object appearing within the detectable region;
an information identifying module comprising an information storage unit and an information comparing unit, the information storage unit storing predetermined images of an object, the information comparing unit configured for identifying the object by comparing a captured image of the object with the predetermined images, the detection module configured for analyzing the captured successive images to determine the movement track of the identified object; and
a signal processing unit configured for generating a cursor control signal based on the movement track signals.

2. The cursor control device of claim 1, further comprising a main body receiving the detection module, the information identifying module and the signal processing unit therein.

3. The cursor control device of claim 2, wherein the information identifying module further comprises a user's ID and password identifying unit, the main body has a display screen and a keyboard mounted thereon for inputting the user's ID and password to activate the detection module.

4. The cursor control device of claim 1, further comprising a wire transmission system and a wireless transmission system, the signal processing unit configured for connection to a host via the wire transmission system or via the wireless transmission system.

5. The cursor control device of claim 1, wherein the detection module is configured for determining the three-dimensional movement track of the object in the detectable region.

6. The cursor control device of claim 1, wherein the signal processing unit is configured for generating a click or double-click signal in response to a resembling click or double-click motion of the object in the detectable region.

7. An apparatus comprising:
a host;
a display electrically connected to the host; and
at least one cursor control device communicatively connected to the host, the at least one cursor control device comprising:
a detection module having an image capturing unit defining a detectable region, the detection module being capable of capturing successive images of the detectable region and analyzing the successive images to generate a movement track signal representative of a movement track of a moving object appearing within the detectable region;
an information identifying module comprising an information storage unit and an information comparing unit, the information storage unit storing predetermined images of an object, the information comparing unit configured for identifying the object by comparing a captured image of the object with the predetermined images, the detection module configured for analyzing the captured successive images to determine the movement track of the identified object; and
a signal processing unit configured for generating a cursor control signal based on the movement track signals.

8. The apparatus of claim 1, wherein the at least one cursor control device includes a number of cursor control devices for controlling movement of a plurality of corresponding cursors on the display.

9. A mobile phone comprising:
a main body;
a camera module mounted on the main body, configured for capturing successive images of a moving object;
an object segmentation module configured for identifying the moving object in the images and determining a movement track of the object;
a signal processing unit configured for generating a cursor control signal for controlling a movement track of a cursor or a scroll bar on a display screen based to the determined movement track of the object; and
a signal sending module configured for communicatively coupling to a computer system and sending the cursor control signal to the computer system.
